(19) United States
(12) Patent Application Publication
(10) Pub. No.: US 2013/0001395 A1
(43) Pub. Date: Jan. 3, 2013

(54) Ground Attachment System for Solar Tracking Device

(75) Inventors: James Schmalzried, San Jose, CA (US); Daniel L. Larner, San Jose, CA (US)

(73) Assignee: Google Inc., Mountain View, CA (US)

(21) Appl. No.: 13/174,171

(22) Filed: Jun. 30, 2011

(51) Int. Cl. F16M 7/00; B23Q 17/00

(52) U.S. Cl. 248/506; 248/509; 29/407.09

(57) ABSTRACT

The subject matter of this specification can be embodied in, among other things, a system for securing a solar tracking device support member to a ground surface. A receiving member is adapted to receive the solar tracking device support member, and an anchor member including an elongate anchor shaft having a longitudinal axis, at least one ground pull-out restraining member disposed on a lower portion of the anchor shaft, and an expanded portion of the anchor shaft disposed longitudinally on an upper portion of the anchor shaft and adapted to support the receiving member. An uppermost portion of the upper portion of the anchor shaft is adapted to pass through an opening in the solar tracking device support. A biasing member is disposed about the uppermost portion of the anchor shaft, and a fastener is removably received on a distal end of the upper portion of the anchor shaft.

### TECHNICAL FIELD

This document relates to ground anchoring devices used in the solar energy field.

### BACKGROUND

Solar energy management, collection, and use can often help alleviate energy problems around the world. In particular, solar energy systems such as photovoltaic (“PV”) systems, which generate electrical energy from solar energy, can reduce dependence on fossil fuels or other power generation techniques. Additionally, solar energy may be used to generate heat that can subsequently be used in power generation systems. In some cases, solar energy collection systems may include multiple heliostats that reflect solar energy to a receiver. The receiver may then focus the reflected solar energy for a variety of uses. In some instances, heliostats are tracking mirrors, which reflect and focus sunlight onto a distant target, such as the receiver.

For optimal operation, heliostats move precisely and maintain a precise aiming angle, even when acted upon by external forces. For instance, it may be desirable to maintain an angle of a beam of sunlight reflected by the heliostat to within +/−1 milliradian. Substantial wind forces on a planar object, such as a heliostat, may apply forces and torques which tend to knock the beam off-target. One source of aiming errors of heliostats is the mechanical bending of a supporting structure under wind loads. Heliostats that are mounted on top of rigid posts firmly anchored to the ground, thereby effectively acting as a cantilevered beam, are subject to wind forces acting to “push over” the posts. To resist bending, the post must be very rigid and anchored securely into the ground. Often, the material and installation cost of rigid posts and secure foundations can be prohibitive to installation of a system of heliostats. The excavation generally required for such installations can be disruptive to the environment, and the secure foundations, once installed, are not generally considered to be removable.

### SUMMARY

In general, this document describes ground anchor devices for solar tracking devices.

In a first aspect, a system for securing a solar tracking device support member to a ground surface includes a receiving member adapted to receive the solar tracking device support member. The system also includes an anchor member including an elongate anchor shaft having a longitudinal axis, at least one ground pull-out restraining member disposed on a lower portion of the anchor shaft. An expanded portion of the anchor shaft is disposed longitudinally on an upper portion of the anchor shaft, said expanded portion adapted to support the receiving member. An uppermost portion of the upper portion of the anchor shaft is adapted to pass through an opening in the solar tracking device support, said opening in the solar tracking device support member transverse to the longitudinal axis of the solar tracking device support member. A biasing member is disposed about the uppermost portion of the anchor shaft, and a fastener is removably received on a distal end of the upper portion of the anchor shaft.

Implementations can include any, all, or none of the following features. The fastener can be adapted to move longitudinally along the uppermost portion of the anchor shaft and compress the biasing member. The biasing member can be a spring, and the fastener can be a nut that is threadably received on an externally threaded portion of the uppermost portion of the anchor shaft. The system can further include an upper spring follower and a lower spring follower adapted to compress the spring when the fastener is moved axially along the anchor shaft toward the expanded portion of the anchor shaft. The receiving member can have a bottom member with a longitudinal axis, said bottom member adapted to receive the solar tracking device support member when a longitudinal axis of the support member is parallel to the longitudinal axis of the bottom member. The receiving member can also include a pair of opposed upstanding side walls attached to the bottom member. The receiving member can also include an upper wing projection disposed outwardly on the distal end of each upstanding wall. The system can also include a second pair of opposed upstanding side walls displaced longitudinally along the axis of the receiving member attached to the bottom of the support member and spaced apart from the first set of upstanding walls. The second set of upstanding side walls can also include an upper wing projection disposed outwardly on the distal end of each upstanding wall. The biasing member can be disposed between the two sets of spaced apart upstanding walls. The wing projections can be adapted to guide the solar tracking device support member into the receiving member. The expanded portion of the anchor shaft can include an upper surface adapted to receive and support the bottom of the support member. The solar tracking device can be a heliostat. The solar tracking device can be a sun position tracker for a system of heliostats.

In a second aspect, a system for securing a solar tracking device support member to a ground surface, said system including a receiving member including a bottom member with a longitudinal axis and with a width greater than a width of the solar tracking device support member when a longitudinal axis of the support member is parallel to the longitudinal axis of the receiving member, a pair of opposed upstanding side walls attached to the bottom member, an upper wing projection disposed outwardly on the distal end of each upstanding wall. An anchor member includes an elongate anchor shaft having a longitudinal axis, at least one ground pull-out restraining member disposed on a lower portion of the anchor shaft, an expanded portion of the anchor shaft disposed longitudinally on an upper portion of the anchor shaft, said expanded portion including an upper surface, and an uppermost portion of the upper portion of the anchor shaft having a diameter sized to pass through a transverse opening in the solar tracking device support, said opening in the solar tracking device support member transverse to the longitudinal axis of the solar tracking device support member. A biasing member is disposed about the upper portion of the anchor shaft, and a fastener is removably received on a distal end of the upper portion of the anchor shaft.

Implementations can include any, all, or none of the following features. The system can include a second pair of opposed upstanding side walls displaced longitudinally along the axis of the receiving member attached to the bottom of the support member and spaced apart from the first set of upstanding walls. The second set of upstanding side walls can include an upper wing projection disposed outwardly on the distal end of each upstanding wall. The biasing member can be disposed between the two sets of spaced apart upstanding walls. The wing projections can be adapted to guide the solar tracking device support member into the receiving member. The solar tracking device can be a heliostat. The solar tracking device can be a sun position tracker for a system of heliostats.

In a third aspect, a system is described for securing a solar tracking device support member to a ground surface, said solar tracking device support member having a top, opposing downwardly disposed side members, and an open bottom. The system includes an anchor member including an elongate anchor shaft having a longitudinal axis, at least one ground pull-out restraining member disposed on a lower portion of the anchor shaft. An expanded portion of the anchor shaft is disposed longitudinally on an upper portion of the anchor shaft, said expanded portion adapted to support the solar tracking device support member. An uppermost portion of the upper portion of the anchor shaft is adapted to pass through an opening in the top of the solar tracking device support member. A biasing member is disposed about the upper portion of the anchor shaft. A fastener is removably received on a distal end of the upper portion of the anchor shaft.

Implementations can include any, all, or none of the following features. The expanded portion of the anchor shaft can have an outside diameter less than an inside width dimension between interior surfaces of the downwardly disposed side walls of the solar tracking device support member. The solar tracking device can be a heliostat. The solar tracking device can be a sun position tracker for a system of heliostats.

In a fourth aspect, a system is described for securing a solar tracking device support member to a ground surface. The solar tracking device support member has a top, opposing downwardly disposed side members, and an open bottom. The system includes an anchor member including an elongate anchor shaft having a longitudinal axis, at least one ground pull-out restraining member disposed on a lower portion of the anchor shaft, an expanded portion of the anchor shaft disposed longitudinally on an upper portion of the anchor shaft, said expanded portion adapted to support the solar tracking device support member, and an uppermost portion of the upper portion of the anchor shaft adapted to pass through an opening in the top of the solar tracking device support member. A biasing member is disposed about the upper portion of the anchor shaft. A fastener is removably received on a distal end of the upper portion of the anchor shaft.

Implementations can include any, all, or none of the following features. The clamp member can include an L-shaped member including a top leg member having an aperture larger than an outer diameter of the upper portion of the anchor shaft and a terminal leg member disposed downwardly at the distal end of the top member. The top of the clamp member can be adapted to contact the top of the solar tracking device support member, and said terminal member of the clamp can be adapted to contact an outer surface of a first side wall of the solar tracking device support member, and said contact member of the shaft can be adapted to contact an external surface of a second side wall of the solar tracking device support. The contact member can be a plate secured to the upper portion of the anchor shaft. The solar tracking device can be a heliostat. The solar tracking device can be a sun position tracker for a system of heliostats.

In a fifth aspect, a method for securing a solar tracking device support member with a longitudinal axis to a ground surface includes installing an anchor member. The anchor member includes an elongate anchor shaft having a longitudinal axis, at least one ground pull-out restraining member disposed on a lower portion of the anchor shaft, an expanded portion of the anchor shaft disposed longitudinally on an upper portion of the anchor shaft, said expanded portion including an upper surface, wherein said ground pull-out restraining member is below the ground surface and the expanded portion of the anchor shaft and the upper portion of the anchor member are above the ground surface. The method also includes positioning a receiving member with an opening in the bottom side thereof on the upper portion of the anchor shaft, wherein a lower side of the bottom member of the receiving member contacts the upper surface of the expanded portion of the anchor shaft, said receiving member further including a longitudinal axis, a pair of opposed upstanding side walls attached to the bottom member, an upper wing projection disposed outwardly on the distal end of each upstanding wall. The solar tracking device support member is aligned such that the longitudinal axis of the support member is parallel to the longitudinal axis of the receiving member. The method also includes positioning the solar tracking device support member between opposing upper wing projections disposed outwardly on the distal end of each upstanding wall of the receiving member, disposing a biasing member above an upper surface of the solar tracking device support member and about the upper portion of the anchor shaft, installing a fastener on a distal end of the upper portion of the anchor shaft, moving the fastener axially along the anchor shaft toward the expanded portion of the anchor shaft, thereby at least partially compressing the biasing member and securing the solar tracking device support member in the receiving member.

Implementations can include any, all, or none of the following features. The method can include a second pair of opposed upstanding side walls and upper wing projection disposed outwardly on the distal end of each additional upstanding wall, said second pair of side walls displaced longitudinally along the axis of the receiving member attached to the bottom of the support member and spaced apart from the first set of upstanding walls. Disposing the biasing member can include positioning the biasing member between the two sets of spaced apart upstanding walls.

In a sixth aspect, a method for securing a solar tracking device support member having a top with an opening there through, a pair of opposing downwardly disposed side members and an open bottom, includes installing an anchor member. The anchor member includes an elongate anchor shaft having a longitudinal axis, at least one ground pull-out restraining member disposed on a lower portion of the anchor shaft, an expanded portion of the anchor shaft disposed longitudinally on an upper portion of the anchor shaft, wherein said ground pull-out restraining member is below the ground surface and the expanded portion of the anchor shaft and the upper portion of the anchor member are above the ground surface. The method also includes aligning the opening in the top of the solar tracking device support member over a distal upper end of the upper portion of the shaft, positioning an interior surface of each of the downwardly disposed side walls of the solar tracking device support member on the expanded portion of the shaft, disposing a biasing member above an upper surface of the top of the solar tracking device support member and about the upper portion of the anchor shaft, installing a fastener on a distal end of the upper portion of the anchor shaft, and moving the fastener axially along the anchor shaft toward the expanded portion of the anchor shaft, thereby at least partially compressing the biasing member and securing the solar tracking device support member on the expanded portion of the shaft.

Implementations can include a feature wherein disposing the biasing member can include positioning the biasing member between the two sets of spaced apart upstanding walls.

In a seventh aspect, a method for securing a solar tracking device support member having a top with an opening there through, a pair of opposing downwardly disposed side members and an open bottom, includes installing an anchor member. The anchor member includes an elongate anchor shaft having a longitudinal axis, at least one ground pull-out restraining member disposed on a lower portion of the anchor shaft, an expanded portion of the anchor shaft disposed longitudinally on an upper portion of the anchor shaft, wherein said ground pull-out restraining member is below the ground surface and the expanded portion of the anchor shaft and the upper portion of the anchor member are above the ground surface. The method also includes aligning the opening in the top of the solar tracking device support member over a distal upper end of the upper portion of the shaft, positioning an interior surface of each of the downwardly disposed side walls of the solar tracking device support member on the expanded portion of the shaft, disposing a biasing member above an upper surface of the top of the solar tracking device support member, and about the upper portion of the anchor shaft, installing a fastener on a distal end of the upper portion of the anchor shaft, and moving the fastener axially along the anchor shaft toward the expanded portion of the anchor shaft, thereby at least partially compressing the biasing member and securing the solar tracking device support member on the expanded portion of the shaft.

In an eighth aspect, a method for securing a solar tracking device support member having a top with an opening there through, downwardly disposed side members, includes installing an anchor member. The anchor member includes an elongate anchor shaft having a longitudinal axis, at least one ground pull-out restraining member disposed on a lower portion of the anchor shaft, a contact member of the anchor shaft disposed longitudinally on an upper portion of the anchor shaft, wherein said ground pull-out restraining member is below the ground surface and the expanded portion of the anchor shaft and the upper portion of the anchor member are above the ground surface. The method also includes positioning a clamp member having a top with an aperture over the upper portion of the anchor shaft, said clamp member further having a terminal member disposed downwardly at the distal end of the top member, contacting the top of the solar tracking device support member with the top of the clamp member and contacting an outer surface of a first side wall of the solar tracking device support member with the terminal member of the clamp and contacting an external surface of a second side wall of the solar tracking device support member with the contact member of the shaft, disposing a biasing member above an upper surface of the top of the clamp of the solar tracking device support member, and about the upper portion of the anchor shaft, installing a fastener on a distal end of the upper portion of the anchor shaft, and moving the fastener axially along the longitudinal axis of the anchor shaft toward the expanded portion of the anchor shaft, thereby at least partially compressing the biasing member and securing the solar tracking device support member between the terminal member of the clamp and the expanded portion of the shaft. It will be understood that alternatively, the ground anchor may be installed by installing the anchor shaft with a contact member; contacting a first side member of the solar tracking device support members with the contact member of the shaft; and installing a clamp to contact the support member.

In a ninth aspect, a method of installing ground anchor members includes providing a plurality of ground anchor members each including an elongate anchor shaft having a longitudinal axis and at least one ground pull-out restraining member disposed on a lower portion of the anchor shaft, providing an installation vehicle adapted to rotatably insert each of the ground anchor members into the ground, said vehicle including a GPS position indicator, positioning the installation vehicle using the GPS position indicator at a first predetermined location for installation of a first ground anchor member, rotating the first ground anchor member to install the ground pull-out restraining member below the ground surface and leaving the expanded portion of the anchor shaft and the upper portion of the anchor member above the ground surface, stopping the rotating of the first ground anchor installation at a predetermined desired azimuthal orientation for the expanded portion of the anchor shaft, detaching the installation vehicle from the first ground anchor member, positioning the installation vehicle at a second predetermined location using the GPS position indicator, repeating the above steps at the second predetermined location.

Implementations can further include positioning a receiving member with an opening in the bottom side thereof on the upper portion of the anchor shaft, wherein a lower side of the bottom member of the receiving member contacts the expanded portion of the anchor shaft, said receiving member further including a longitudinal axis, a pair of opposed upstanding side walls attached to the bottom member, and an upper wing projection disposed outwardly on the distal end of each upstanding wall, aligning a solar tracking device support member such that a longitudinal axis of the support member is parallel to the longitudinal axis of the receiving member, and positioning the solar tracking device support member between opposing upper wing projections disposed outwardly on the distal end of each upstanding wall of the receiving member.

The systems and techniques described here may provide one or more of the following advantages. First, a system can provide an efficient and cost effective way to install solar tracking devices. The system can be installed with a reduced environmental impact relative to other commonly used foundation or anchoring techniques. The system can accommodate settling and shifting of the solar tracking device and/or the surrounding ground surface. The system can be removable. The system can be installed through an automated or semi-automated installation and alignment process.

The details of one or more implementations are set forth in the accompanying drawings and the description below. Other features and advantages will be apparent from the description and drawings, and from the claims.

### DESCRIPTION OF DRAWINGS

FIG. 1 is a perspective view of an example of a solar tracking device that employs an example ground attachment.

FIG. 2 is a perspective view of an example ground attachment.

FIG. 2A is a detailed perspective view of the example ground attachment of FIG. 2.

FIG. 2B is a detailed side view of the example ground attachment of FIG. 2.

FIG. 2C is an end view of an example ground attachment that is substantially unbiased.

FIG. 2D is an end view of an example ground attachment with a bias applied.

FIG. 3 is an end view of another configuration of an example ground attachment.

FIG. 4A is a perspective view of another configuration of an example ground attachment.

FIG. 4B is an end view of the example ground attachment of FIG. 4A.

FIGS. 5-8 are flow diagrams illustrating example processes for using the ground attachments of FIGS. 1-4B.

### DETAILED DESCRIPTION

This document describes systems and techniques for anchoring heliostats, solar collectors, or other structures to the ground. In general, the ground attachments include a shaft with an auger on one end that is drilled into the ground to resist the shaft from being pulled out of the ground. As discussed hereinafter, other pull-out restraining members can be used to secure the shaft in the ground. The other end of the shaft includes a receiving member to at least partly capture and retain part of a structure, such as a heliostat support. The ground attachment also includes a compliant member that can be biased to maintain retention of the structure as the supporting ground shifts and settles over time.

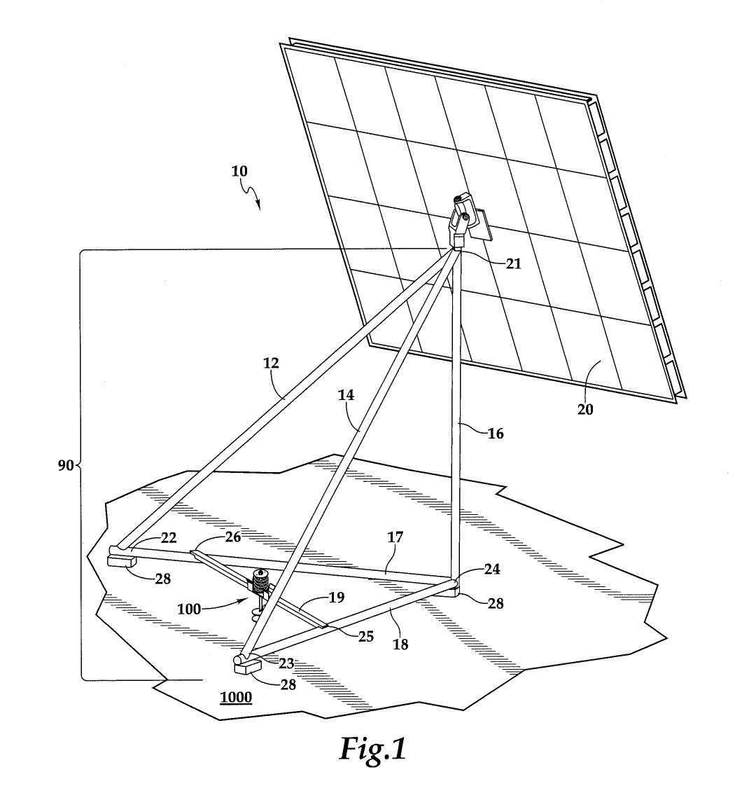

FIG. 1 is a perspective view of an example of solar tracking device 10 that employs an example ground attachment 100. The solar tracking device 10 includes a mirror 20 coupled to a support structure 90 to elevate the mirror 20 above a ground surface 1000. In some implementations, however, the mirror 20 may be replaced by a solar collector (e.g., photovoltaic panel, solar thermal collector, solar chemical collector).

The support structure 90 includes a support leg 12, a support leg 14, and a support leg 16. The support legs 12-16 are arranged in a tripod configuration in which the upper ends of the support legs 12-16 substantially converge at an apex 21. The lower ends of the support legs 12-16 are coupled to a longitudinal support member 17 and to a longitudinal support member 18. The support leg 12 is coupled to the longitudinal support member 17 at a coupling 22. The support leg 14 is coupled to the longitudinal support member 18 at a coupling 23. The support leg 16 is coupled to the longitudinal support members 17 and 18 at a coupling 24.

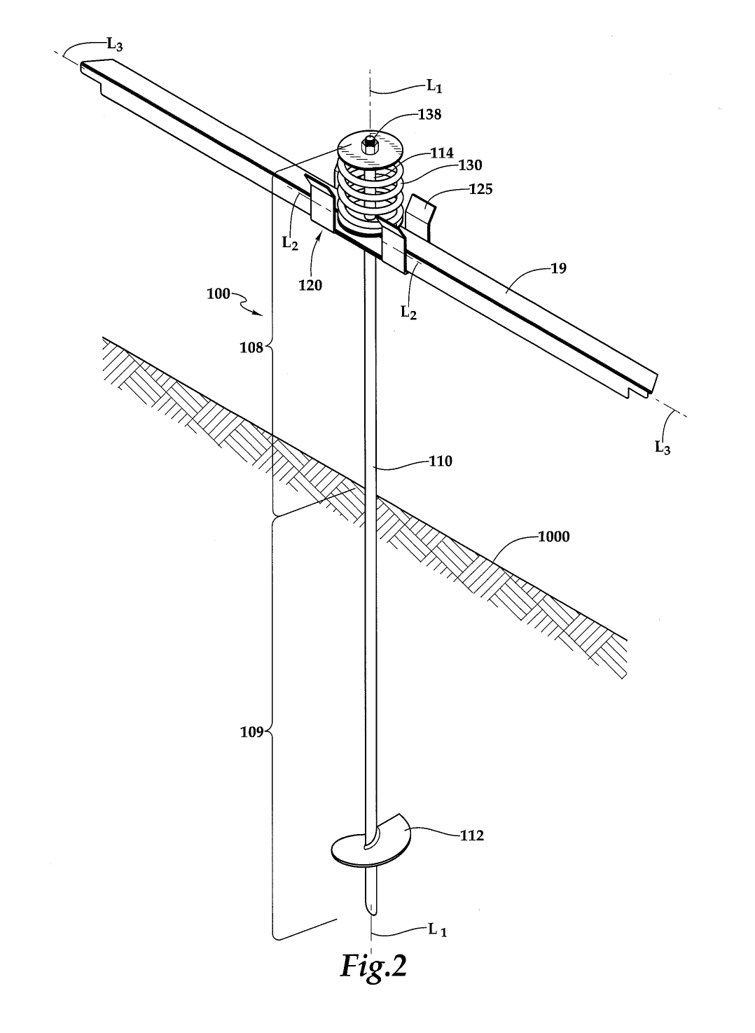

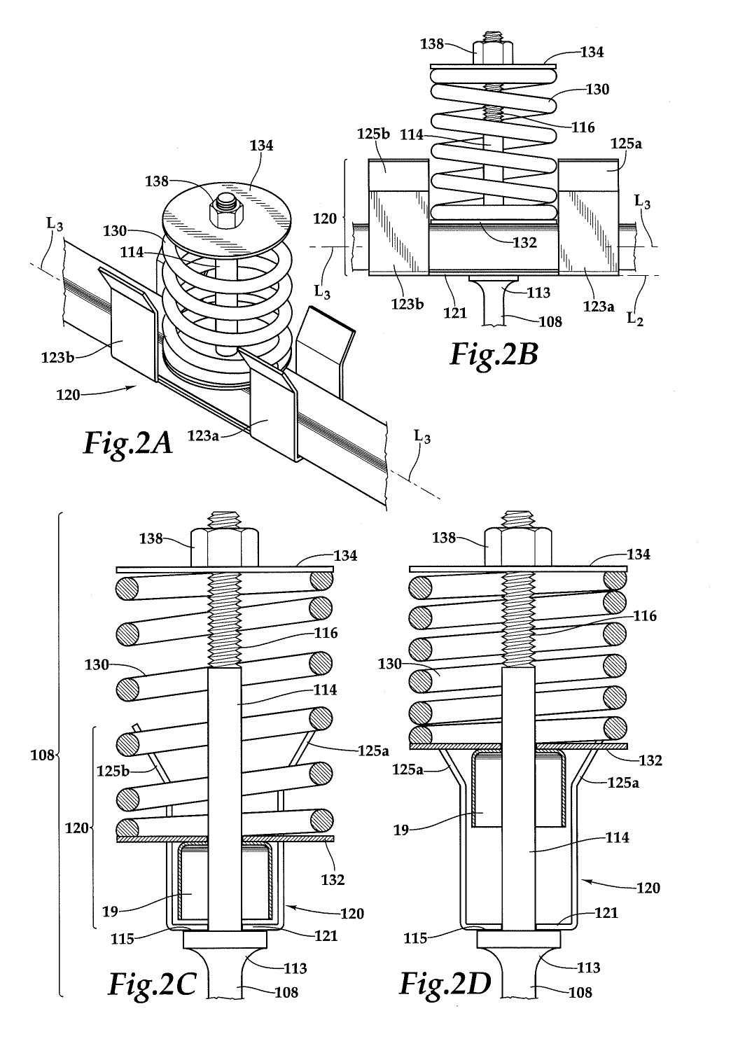

The ground attachment 100, which is discussed in additional detail in the discussion of FIGS. 2-4B, is augered into the ground such that a lower portion is located below the ground surface 1000 and an upper portion is located above the ground surface 1000. The ground attachment 100, when installed through the ground surface 1000, resists axial forces acting upon the upper portion, such that the upper portion is usable to retain a support member 19. Examples of retentive structures are discussed in the descriptions of FIGS. 2-4B. One end of the support member 19 is coupled to the longitudinal support member 17 at a coupling 25, and the opposite end of the support member 19 is coupled to the longitudinal support member 18 at a coupling 26. As such, the support structure 90 is retained against the ground surface 1000 by the retentive forces applied by the ground attachment 100 through the support member 19.

The support structure 90 includes support footings 28 located at the couplings 22-24. The support footings 28 are arranged such that the support footings 28 contact and partly penetrate the ground surface 1000 at points below the couplings 22-24. For example, the retentive forces provided by the ground attachment 100 can tend to draw the footings 28 into penetrative contact with the ground surface 1000. In some implementations, the footings 28 may be formed as substantially vertical spikes, blades, fins, wedges, or other appropriate structures that may penetrate the ground surface 1000 and resist lateral movement across or through the ground surface. For example, the ground attachment 100 may provide retentive force that resists vertical movement of the solar tracking device 10, and the footings 28 may provide retentive forces that resist rotational movement of the solar tracking device 10 about the ground attachment 100.

FIG. 2 is a perspective view of an example ground attachment 100. The ground attachment 100 includes a shaft 110 having an axis L1. The shaft 110 includes an upper portion 108 and a lower portion 109. In general, when the ground attachment 100 is installed in the ground, the upper portion 108 remains substantially above the ground surface 1000, and the lower portion 109 remains substantially below the ground surface 1000.

The lower portion 109 includes a pull-out restraining member 112. In use, the pull-out restraining member 112 generally serves two purposes. During some methods of installation of the ground attachment 100, the shaft 110 is rotated such that the pull-out restraining member 112 spirals into the ground, drawing the ground attachment 100 toward the ground surface 1000. Once spiraled to the desired depth, the pull-out restraining member 112 resists forces acting to pull the ground attachment 100 out of the ground surface (i.e., tensile forces acting along the axis L1). In another installation method, a hole may be opened in the ground and the lower portion 109 and pull-out restraining member 112 placed in the open hole and material backfilled in the hole, thereby resisting forces acting to pull the ground attachment 100 out of the ground.

As used herein, “ground pull-out restraining member” includes any member attached to the anchor shaft that resists pullout of the anchor shaft from the ground by an upwards force applied to the anchor shaft. Such members can include, but are not limited to, one or more auger plates; helical and spiral auger flights, single or multiple screw flights, and/or spikes.

In some implementations, use of the ground attachment 100 can provide cost and installation time savings. For example, use of the ground attachment 100 can substantially reduce the amount of site preparation (e.g., ground leveling, grating), foundation installation (e.g., digging holes, pouring support footings), and the attachment and alignment of solar tracking structures to such a foundation. In some implementations, use of the ground anchor 100 can reduce the environmental impact of installing solar tracking structures. For example, use of the ground anchor 100 can be less invasive to the installation site terrain than are more traditional support structures.

In some implementations, the ground anchor 100 can be removed by augering the ground anchor 100 in the rotationally opposite direction from what was used to install the ground anchor 100. For example, the ground anchor 100 can be removed, moved to another location, and reinstalled, all substantially without making a permanent impact at the original installation site.

Referring now to FIGS. 2A and 2B, an uppermost portion 114 of the upper portion 108 of the shaft 110 is passed through a hole (not shown) in a bottom member 121 of a receiving member 120 until the bottom member 121 contacts an expanded portion 113 of the upper portion 108 of the shaft 110. As such, the expanded portion 113 substantially retains the receiving member 120 in one direction along axis L1.

In use, the support member 19 is placed onto the receiving member 120. The uppermost portion 114 passes through a hole (not shown) formed in the support member 19 until coming into contact with the bottom member 121. A set of wing projections 125a, 125b are disposed outwardly on the distal ends of a set of upstanding walls 123a, 123b coupled to the bottom member 121 at substantially right angles to the plane of the bottom member 121. As such, the wing projections 125a, 125b guide the support member 19 during installation onto the uppermost portion 114, and the upstanding walls 123a, 123b retain the support member 19 such that a longitudinal axis L3 of the support member 19 substantially aligns with a longitudinal axis L2 of the receiving member 120.

The support member 19 is retained axially in the receiving member 120 by a biasing member 130. In the illustrated example, the biasing member 130 is a coil spring, but in some implementations, the biasing member 130 may be a leaf spring, a wave spring, a compliant material (e.g., rubber), a pneumatic cylinder, or any other appropriate material or mechanism that can compliantly store and return a compressive force applied to it.

In use, a lower follower 132 is placed over the uppermost portion 114 and is brought into contact with the support member 19. The biasing member 130 is then placed over the uppermost portion 114 and is brought into contact with the lower follower 132. As such, the lower follower 132 provides surface area over which the biasing member 130 can apply force to the support member 19. An upper follower 134 is placed over the upper portion 111 until it contacts the biasing member 130. In some implementations, the lower follower 132 and the upper follower 134 can be washers. In some implementations, the uppermost portion 114 includes a threaded section 116 onto which a fastener 138 (e.g., a nut) is threaded. The fastener 138 is threaded onto the threaded section 116 to contact the upper follower 134. As the fastener 138 is adjustably positioned axially along the threaded section 116 the follower 132 applies a compressive bias to the biasing member 130. The biasing member 130, in turn, provides a compliant bias against the support member 19.

In some implementations, the application of the compliant bias to the support member 19 may reduce the amount of time required to install the solar tracking device 10. For example, the support member may be coupled to the ground attachment 100 by tightening the fastener 138 until the biasing member 130 appears to be substantially compressed (e.g., reducing the need and time to tighten the fastener 138 to predetermined torque specification). In some implementations, the use of the compliant bias to retain the support member 19 may reduce the time and labor used to maintain the solar tracking device 10. For example, over time the ground upon which the solar tracking device 10 is located may erode or shift, or the footings 28 may sink into the ground surface 1000. As such, the support member 19 may shift axially downward along the shaft 110, and the biasing member 130 may expand to maintain a force upon the support member 19 that is transferred to maintain a downward force upon the support structure 90, keeping the support structure in contact with the ground surface 1000.

FIG. 2C is an end view of the example ground attachment 100 when it is substantially unbiased. The compliant nature of the biasing member 130 permits the support member 19 to travel axially along the axis L1 (e.g., generally vertical travel in most applications).

In the illustrated example of FIG. 2C, biasing member 130 is substantially unbiased, and the support member 19 is substantially at a bottom extent of the compliant range 202. In some implementations, this may be an initial installation configuration. For example, in climates that experience wide seasonal temperature variations or rainfall amounts, the ground surface 1000 may shift, swell, or heave vertically relative to the ground attachment 100.

FIG. 2D is an end view of the example ground attachment 100 with a bias applied. In the illustrated example, the support member 19 is located near the upper end of the compliant range and the biasing member 130 is substantially compressed.

In some implementations, this illustration may represent the configuration of the support member 19 and the ground attachment 100 some time after the solar tracking device 10 has been installed. For example, the ground attachment 100 may have been installed in a configuration represented by FIG. 2C, but over time the surrounding ground surface 1000 may have swelled vertically relative to the ground attachment 100 (e.g., plant roots have grown in the vertical layer between the pull-out restraining member 112 and the footings 28). As illustrated in FIG. 2D, such upheaval of the ground surface 1000 may cause the support structure 90 to be lifted vertically relative to the ground attachment 100, thus causing the support member 19 to travel vertically along the compliant range and increase the bias on the biasing member 130.

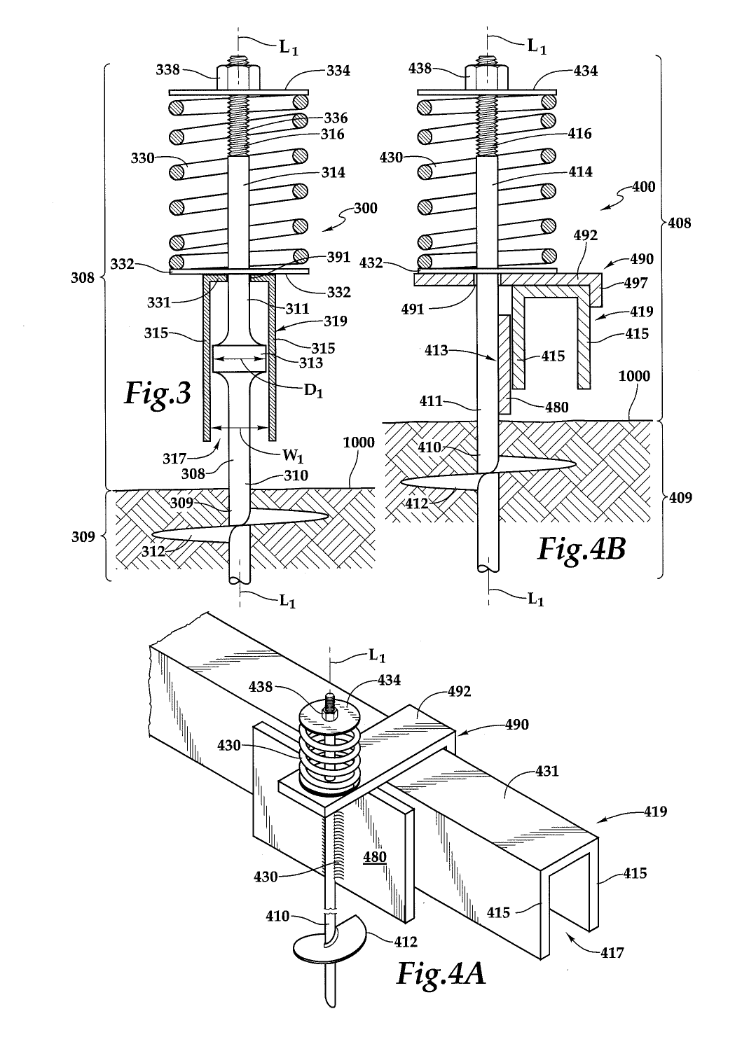

FIG. 3 is an end view of another configuration of an example ground attachment 300 for securing a support member 319 to the ground surface 1000. In some implementations, the support member 319 may be the support member 19 of FIG. 1. The ground attachment 300 includes a shaft 310. The shaft 310 includes a pull-out restraining member 312 disposed on a lower portion 309 of shaft 410. In use, the pull-out restraining member 312 is installed into the ground surface 1000, with the lower portion 309 of shaft 310 at least partly into the ground surface 1000, leaving an upper portion 308 exposed above the ground surface 1000.

The support member 319 includes an upper member 331 oriented substantially planar to the ground surface 1000, a pair of opposing downwardly disposed side members 315, and an open bottom 317. The upper member 331 includes an opening 391 through which the upper portion 311 is passed. The support member 319 is lowered along the uppermost portion 314 of the upper portion 311 of the shaft 310 until the upper member 331 encounters an expanded portion 313 of the shaft 310. The expanded portion 313 of the shaft 310 has an outside diameter D1 less than an inside width dimension W1 between interior surfaces of the side members 315 of the support member 319.

A lower follower 332 is assembled over the upper portion 314 until it contacts the upper member 331. A biasing member 330 is assembled over the upper portion 311 and rests upon the lower follower 332, and an upper follower 334 is assembled over the upper portion 314 to rest upon the biasing member 330.

The support member 319, the lower follower 332, the biasing member 330, and the upper follower 334 are secured in place by a fastener 338. The fastener 338 is threaded onto a threaded section 336 of the upper portion 314. The upper follower 334 and the lower follower 332 are adapted to compress the biasing member 330 when the fastener 338 is moved axially along the uppermost portion 314 of the shaft 310 toward the expanded portion 313 of the shaft 310.

FIGS. 4A and 4B show a perspective and side view of another configuration of an example ground attachment 400. The ground attachment 400 includes an elongate anchor shaft 410 having a longitudinal axis L1, and a ground pull-out restraining member 412 disposed on a lower portion 409 of the anchor shaft 410. A contact member 413 of the anchor shaft 410 is disposed longitudinally on an upper portion 408 of the anchor shaft 410. In use, the ground pull-out restraining member 412 is installed below the ground surface 1000 and the expanded portion 413 of the anchor shaft 410 and the upper portion 408 of the ground attachment 400 are above the ground surface 1000. A plate 480 is coupled to the anchor shaft at the expanded portion 413, and extends substantially tangent to the anchor shaft 410.

The ground anchor 400 also includes a clamp member 490. The clamp member 490 is a substantially L-shaped member that includes a top member 492 with an aperture 491. The aperture 491 is adapted for receiving the uppermost portion 414 of the anchor shaft 410. The clamp member 490 also includes a terminal member 497 disposed downwardly at the distal end of the top member 492.

The clamp member 490 is adapted to secure a support member 419. The support member 419 includes a top 431, a pair of downwardly disposed side members 415, and an open bottom 417. The clamp member 490 secures the top 431 and an outer surface of one of the side walls 415 of the support member 419, and the plate 480 supports the outer surface of the opposite side walls 415.

The clamp member 490 is secured to the upper portion 411 of the anchor shaft 410 by first assembling a lower follower 432 over the uppermost portion 414 until it rests against the top 492 of the clamp member 490. A biasing member 490 is assembled over the uppermost portion 414 until it rests against the lower follower 432. An upper follower 434 is assembled over the uppermost portion 414 until it rests upon the biasing member 430. A fastener 438 is threaded onto a threaded section 416 of the uppermost portion 414 to retain the clamp member 490, the lower follower 432, the biasing member 430, and the upper follower 434 on the anchor shaft 410.

In use, the support member 419 is secured by the clamp member 490 and the plate 480. A downward biasing force is applied to the support member 419 by adjustably threading the fastener 438 longitudinally along the threaded section 416 to compress the biasing member 430. By adjustably threading the fastener 438, an adjustable bias is applied to the support member 419. In some implementations, the fastener 438 may be a nut that is threadably received on the threaded section 416 of the uppermost portion 414 of the anchor shaft 410.

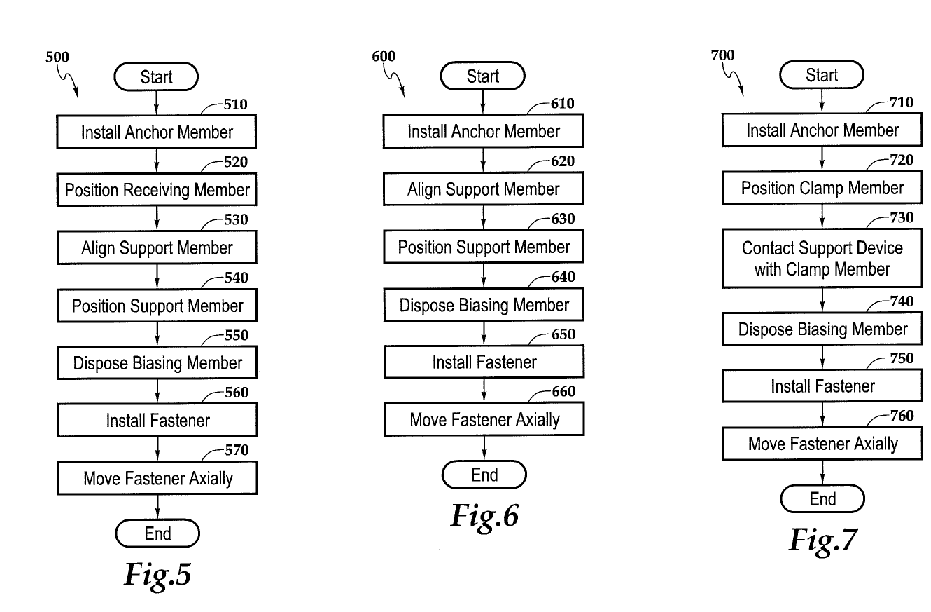

FIG. 5 is a flow chart of an example process 500 for using the ground anchor 100 of FIGS. 1-2D. At step 510 an anchor member is installed in the ground. For example, the ground anchor 100 is augered into the ground surface 1000.

At step 520, a receiving member with an opening in the bottom side thereof is positioned on the upper portion of the anchor shaft. For example, a lower side of the bottom member 121 of the receiving member 120 is brought into contact with the upper surface 115 of the expanded portion 113 of the shaft 110.

At step 530, a support member is aligned with the longitudinal axis of the receiving member. For example, the longitudinal axis L3 of the support member 19 is aligned with the longitudinal axis L2 of the receiving member 120 and between the opposing upper wing projections 125 disposed outwardly on the distal end of each of the upstanding walls 123.

At step 540, the support member is positioned. For example, support member 19 is positioned between the pair of upstanding side walls 123 of the receiving member 120.

At step 550, the biasing member is disposed above an upper surface of the solar tracking device support member. For example, the biasing member 130 can be disposed above an upper surface of the support member 19, and about the uppermost portion 114 of the anchor shaft 110.

At step 560, a fastener is installed. For example, the fastener 138 is positioned on a distal end of the threaded portion 114 of the anchor shaft 110. At step 570, the fastener is moved axially. For example, the fastener 138 can be threaded axially along the anchor shaft 110 toward the expanded portion 113 of the anchor shaft 110 thereby at least partially compressing the biasing member 130 and securing the support member 19 in the receiving member 120.

FIG. 6 is a flow chart of an example process 600 for using the ground anchor 300 of FIG. 3. At step 610 an anchor member is installed in the ground. For example, the ground anchor 300 is augered into the ground surface 1000.

At step 620, an opening in the support member is aligned over a distal upper end of the upper portion of a shaft of the anchor member. For example, the opening 391 is aligned over the threaded portion 316.

At step 630, an interior surface of each of a pair of downwardly disposed side walls of the solar tracking device support member is positioned on an expanded portion of the shaft. For example, the interior surface of each of the downwardly disposed side walls 315 of the solar tracking device support member 319 can be positioned on the expanded portion 313 of the shaft 310.

At step 640, a biasing member is disposed above an upper surface of the solar tracking device support member. For example, the biasing member 330 can be disposed above an upper surface of the support member 319, and about the upper portion 314 of the anchor shaft 310.

At step 650, a fastener is installed. For example, the fastener 338 is positioned on a distal end of the threaded portion 316 of the anchor shaft 310. At step 660, the fastener is moved axially. For example, the fastener 338 can be threaded axially along the uppermost portion 314 of anchor shaft 310 toward the expanded portion 313 of the anchor shaft 310, thereby at least partially compressing the biasing member 330 and securing the support member 319 against the expanded portion 313.

FIG. 7 is a flow chart of an example process 700 for using the ground anchor 400 of FIGS. 4A and 4B. At step 710 an anchor shaft is installed in the ground. For example, the ground anchor 400 is augered into the ground surface 1000.

At step 720, a clamp member having a top with an aperture is positioned over the upper portion of the anchor shaft, said clamp member further having a terminal member disposed downwardly at the distal end of the top member. For example, the clamp member 490 having the aperture 491 is positioned on the shaft 410. The clamp member 490 includes the terminal member 497 disposed downwardly at the distal end of the top member 492.

At step 730, the top of the solar tracking device support member is brought into contact with the top of the clamp member. For example, the top 431 of the solar tracking device support member 419 is brought into contact with the top 492 of the clamp member 490. The outer surface of one of the side walls 415 of the solar tracking device support member 419 is brought into contact with the terminal member 497 of the clamp 490. The external surface of another side wall 415 of the solar tracking device support member 419 is also brought into contact with the contact member 413 of the shaft 410.

At step 740, a biasing member is disposed above an upper surface of the clamp and about the upper portion of the anchor shaft. For example, the biasing member 430 can be disposed above an upper surface of the clamp member 490 and about the upper portion 414 of the shaft 410.

At step 750, a fastener is installed. For example, the fastener 438 is positioned on a distal end of the threaded portion 416 of the anchor shaft 410. At step 760, the fastener is moved axially. For example, the fastener 438 can be threaded axially along the anchor shaft 410 toward the expanded portion 413 of the anchor shaft 410 thereby at least partially compressing the biasing member 430 and securing the support member 419 between the terminal member 497 of the clamp member 490 and the expanded portion 413 of the shaft 410.

Alternatively, the ground anchor 400 may installed by installing the anchor shaft 410 with a contact member 480; contacting a first side member 415 of solar tracking device support member 419 with the contact member 480 of shaft 410; and installing clamp 490 to contact the support member 419.

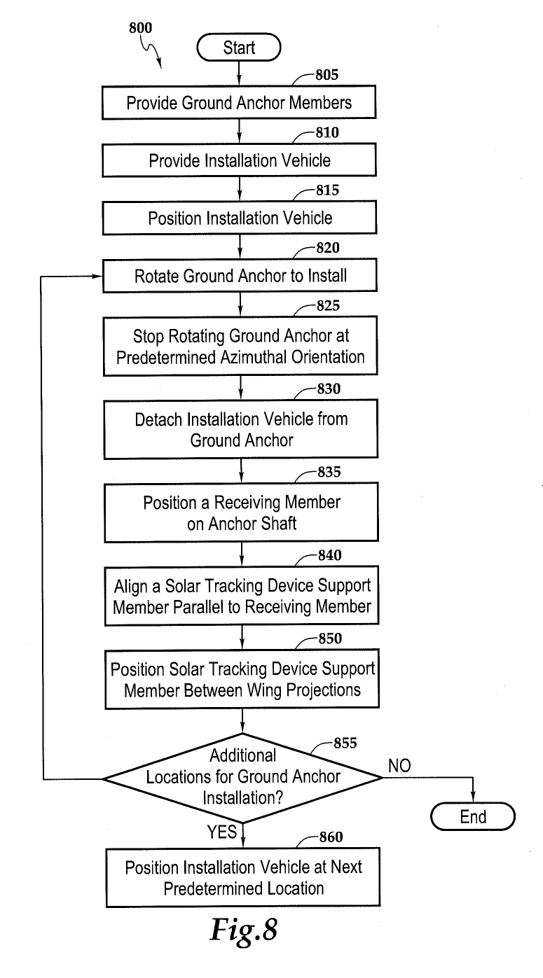

FIG. 8 is a flow chart of an example process 800 for installing a ground anchor such as the anchor 100, 300 and 400 illustrated and described herein. In general, ground anchors described previously can be adapted to automated install techniques. At step 805, a number of ground anchor members are provided, each including an elongate anchor shaft having a longitudinal axis and at least one ground pull-out restraining member disposed on a lower portion of the anchor shaft. For example, the anchor 100 has an axis L1 and the pull-out restraining member 112 included on the lower portion 109.

At step 810 an installation vehicle adapted to rotatably insert each of the ground anchor members into the ground is provided, said vehicle including a global positioning system (GPS) position indicator. At step 815, the installation vehicle is positioned using the GPS position indicator at a predetermined location for installation of one of the ground anchor members. In some implementations, the vehicle may be driven manually or could be at least partly automated. For example, the vehicle can move across a field and stop at predetermined GPS locations.

At step 820, the ground anchor is rotated to install the ground pull-out restraining member below the ground surface and leaving the expanded portion of the anchor shaft and the upper portion of the anchor member above the ground surface. For example, the vehicle can have an apparatus that grips the anchor by the upper portion, and drive it into the ground at the predetermined location. This installing apparatus can be equipped with sensors such that the rotational position of the anchor member can be known (e.g., the orientation of the L2 axis).

At step 825, the rotating of the first ground anchor installation is stopped at a predetermined desired azimuthal orientation for the expanded portion of the anchor shaft. In some implementations, based on the overall heliostat field layout, each heliostat position can have a predetermined desired orientation (e.g. facing north at 0 degree heading, or facing a 17 degree heading). In some implementations, the installing apparatus can drive the anchor member into the ground until the desired orientation of the L2 axis is reached and a support receiving member is near the ground.

At step 830, the installation vehicle is detached from the ground anchor member. At step 835, a receiving member, with an opening in the bottom side thereof on the upper portion of the anchor shaft, is positioned such that a lower side of the bottom member of the receiving member contacts the expanded portion of the anchor shaft, said receiving member further including a longitudinal axis, a pair of opposed upstanding side walls attached to the bottom member, and an upper wing projection disposed outwardly on the distal end of each upstanding wall.

At step 840, a solar tracking device support member is aligned such that a longitudinal axis L3 of the support member is parallel to the longitudinal axis L2 of the receiving member. At step 845, the solar tracking device support member is positioned between opposing upper wing projections disposed outwardly on the distal end of each upstanding wall of the receiving member. For example, as discussed previously in the description of FIG. 2A, the support member 19 can be placed onto the receiving member 120. The uppermost portion 114 can pass through a hole formed in the support member 19 until coming into contact with the bottom member 121. The set of wing projections 125a, 125b are disposed outwardly on the distal ends of a set of upstanding walls 123a, 123b coupled to the bottom member 121 at substantially right angles to the plane of the bottom member 121. As such, the wing projections 125a, 125b can guide the support member 19 during installation onto the uppermost portion 114, and the upstanding walls 123a, 123b can retain the support member 19 such that the longitudinal axis L3 of the support member 19 substantially aligns with the longitudinal axis L2 of the receiving member 120.

If at step 850, one or more additional locations for ground anchor installations exist, then at step 855 the installation vehicle is positioned at another predetermined location using the GPS position indicator and the process repeats at step 820. If at step 850 no additional locations exist, then the process 800 ends.

In some implementations, during heliostat installation the support member 19 can be aligned to follow the predetermined orientation of the anchor member 100. For example, the L3 axis of the support member 19 can be driven to align with the L2 axis of the receiving member 120. The upstanding walls 123 along with the wing projections 125 aid in this alignment by providing a guide for the support member 19 (e.g., a substantially self-centering ability). When the support member 19 comes to a rest in the receiving member 120 and/or on the ground surface 1000, the heliostat structure can be guided to be oriented in the predetermined desired orientation. At this point, the remainder of the anchoring can be accomplished (e.g., application of the biasing member 130 and the fastener 138).

In some implementations, the process 800 can reduce the amount of time it takes to orient a heliostat structure in the heliostat field, as at least some of the alignment can be done by an automated system on the ground anchor installing vehicle. In such examples, the manual labor in the field may not have to align the structure (e.g., with levels, lasers, compass, surveyor equipment), thereby reducing the time and cost of installing a heliostat structure.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A system for securing a solar tracking device support member to a ground surface, said system comprising:
a receiving member adapted to receive the solar tracking device support member;
an anchor member including:
an elongate anchor shaft having a longitudinal axis,
at least one ground pull-out restraining member disposed on a lower portion of the anchor shaft,
an expanded portion of the anchor shaft disposed longitudinally on an upper portion of the anchor shaft, said expanded portion adapted to support the receiving member;
an uppermost portion of the upper portion of the anchor shaft adapted to pass through an opening in the solar tracking device support, said opening in the solar tracking device support member transverse to the longitudinal axis of the solar tracking device support member;
a biasing member disposed about the uppermost portion of the anchor shaft;
a fastener removably received on a distal end of the upper portion of the anchor shaft.

2. The system of claim 1 wherein the fastener is adapted to move longitudinally along the uppermost portion of the anchor shaft and compress the biasing member.

3. The system of claim 2 wherein the biasing member is a spring and the fastener is a nut that is threadably received on an externally threaded portion of the uppermost portion of the anchor shaft.

4. The system of claim 3 further including an upper spring follower and a lower spring follower adapted to compress the spring when fastener is moved axially along the anchor shaft toward the expanded portion of the anchor shaft.

5. The system of claim 1 wherein the receiving member has a bottom member with a longitudinal axis, said bottom member adapted to receive the solar tracking device support member when a longitudinal axis of the support member is parallel to the longitudinal axis of the bottom member.

6. The system of claim 5 wherein the receiving member further includes a pair of opposed upstanding side walls attached to the bottom member.

7. The system of claim 6 wherein the receiving member further includes an upper wing projection disposed outwardly on the distal end of each upstanding wall.

8. The system of claim 7 further including a second pair of opposed upstanding side walls displaced longitudinally along the axis of the receiving member attached to the bottom of the support member and spaced apart from the first set of upstanding walls.

9. The system of claim 6 wherein the second set of upstanding side walls further includes an upper wing projection disposed outwardly on the distal end of each upstanding wall.

10. The system of claim 9 wherein the biasing member is disposed between the two sets of spaced apart upstanding walls.

11. The system of claim 7 wherein said wing projections are adapted to guide the solar tracking device support member into the receiving member.

12. The system of claim 1 wherein the expanded portion of the anchor shaft includes an upper surface adapted to receive and support the bottom of the support member.

13. The system of claim 1 wherein the solar tracking device is a heliostat.

14. The system of claim 1 wherein the solar tracking device is a sun position tracker for a system of heliostats.

15. A system for securing a solar tracking device support member to a ground surface, said solar tracking device support member having a top, opposing downwardly disposed side members, and an open bottom, said system comprising:
an anchor member including:
an elongate anchor shaft having a longitudinal axis,
at least one ground pull-out restraining member disposed on a lower portion of the anchor shaft,
an expanded portion of the anchor shaft disposed longitudinally on an upper portion of the anchor shaft, said expanded portion adapted to support the solar tracking device support member; and
an uppermost portion of the upper portion of the anchor shaft adapted to pass through an opening in the top of the solar tracking device support member;
a biasing member disposed about the upper portion of the anchor shaft;
a fastener removably received on a distal end of the upper portion of the anchor shaft.

16. The system of claim 15 wherein the expanded portion of the anchor shaft has an outside diameter less than an inside width dimension between interior surfaces of the downwardly disposed side walls of the solar tracking device support member.

17. The system of claim 15 wherein the solar tracking device is a heliostat.

18. The system of claim 15 wherein the solar tracking device is a sun position tracker for a system of heliostats.

19. A system for securing a solar tracking device support member to a ground surface, said solar tracking device support member having a top and downwardly disposed side members, said system comprising:
an anchor member including:
an elongate anchor shaft having a longitudinal axis,
at least one ground pull-out restraining member disposed on a lower portion of the anchor shaft,
a contact member of the anchor shaft disposed longitudinally on an upper portion of the anchor shaft, said contact member adapted to contact an external side of one of the side walls of the solar tracking device support member; and
an uppermost portion of the upper portion of the anchor shaft;
a clamp member having a top with an aperture, said aperture adapted for receiving the uppermost portion of the upper portion of the anchor shaft, said clamp member further having a terminal member disposed downwardly at the distal end of the top member, said clamp member adapted to secure the top and an outer surface of one of the side walls of the solar tracking device support member;
a biasing member disposed above the top of the clamp member and about the upper portion of the anchor shaft;
a fastener removably received on a distal end of the upper portion of the anchor shaft.

20. The system of claim 19 wherein the clamp member comprises an L-shaped member including a top leg member having an aperture larger than an outer diameter of the upper portion of the anchor shaft and a terminal leg member disposed downwardly at the distal end of the top member.

21. The system of claim 19 wherein said top of the clamp member is adapted to contact the top of the solar tracking device support member, and said terminal member of the clamp is adapted to contact an outer surface of a first side wall of the solar tracking device support member, and said contact member of the shaft is adapted to contact an external surface of a second side wall of the solar tracking device support.

22. The system of claim 19 wherein said contact member is a plate secured to the upper portion of the anchor shaft.

23. The system of claim 19 wherein the solar tracking device is a heliostat.

24. The system of claim 19 wherein the solar tracking device is a sun position tracker for a system of heliostats.

25. A method for securing a solar tracking device support member with a longitudinal axis to a ground surface, said method comprising:
installing an anchor member including:
an elongate anchor shaft having a longitudinal axis, at least one ground pull-out restraining member disposed on a lower portion of the anchor shaft,
an expanded portion of the anchor shaft disposed longitudinally on an upper portion of the anchor shaft, said expanded portion including an upper surface,
wherein said ground pull-out restraining member is below the ground surface and the expanded portion of the anchor shaft and the upper portion of the anchor member are above the ground surface;
positioning a receiving member with an opening in the bottom side thereof on the upper portion of the anchor shaft, wherein a lower side of the bottom member of the receiving member contacts the upper surface of the expanded portion of the anchor shaft, said receiving member further including a longitudinal axis, a pair of opposed upstanding side walls attached to the bottom member, an upper wing projection disposed outwardly on the distal end of each upstanding wall;
aligning the solar tracking device support member such that the longitudinal axis of the support member is parallel to the longitudinal axis of the receiving member;
positioning the solar tracking device support member between opposing upper wing projections disposed outwardly on the distal end of each upstanding wall of the receiving member;
disposing a biasing member above an upper surface of the solar tracking device support member, and about the upper portion of the anchor shaft;
installing a fastener on a distal end of the upper portion of the anchor shaft;
moving the fastener axially along the anchor shaft toward the expanded portion of the anchor shaft thereby at least partially compressing the biasing member and securing the solar tracking device support member in the receiving member.

26. The method of claim 25 wherein the receiving member further includes a second pair of opposed upstanding side walls and upper wing projection disposed outwardly on the distal end of each additional upstanding wall, said second pair of side walls displaced longitudinally along the axis of the receiving member attached to the bottom of the support member and spaced apart from the first set of upstanding walls.

27. The method of claim 26 wherein disposing the biasing member includes positioning the biasing member between the two sets of spaced apart upstanding walls.

28. A method for securing a solar tracking device support member having a top with an opening there through, a pair of opposing downwardly disposed side members and an open bottom, said method comprising:
installing an anchor member including:
an elongate anchor shaft having a longitudinal axis, at least one ground pull-out restraining member disposed on a lower portion of the anchor shaft, an expanded portion of the anchor shaft disposed longitudinally on an upper portion of the anchor shaft, wherein said ground pull-out restraining member is below the ground surface and the expanded portion of the anchor shaft and the upper portion of the anchor member are above the ground surface;
aligning the opening in the top of solar tracking device support member over a distal upper end of the upper portion of shaft;
positioning an interior surface of each of the downwardly disposed side walls of the solar tracking device support member on the expanded portion of the shaft;
disposing a biasing member above an upper surface of the top of the solar tracking device support member, and about the upper portion of the anchor shaft;
installing a fastener on a distal end of the upper portion of the anchor shaft;
moving the fastener axially along the anchor shaft toward the expanded portion of the anchor shaft thereby at least partially compressing the biasing member and securing the solar tracking device support member on the expanded portion of the shaft.

29. A method for securing a solar tracking device support member having a top with an opening there through, downwardly disposed side members, said system comprising:
installing an anchor member including: an elongate anchor shaft having a longitudinal axis, at least one ground pull-out restraining member disposed on a lower portion of the anchor shaft, a contact member of the anchor shaft disposed longitudinally on an upper portion of the anchor shaft, wherein said ground pull-out restraining member is below the ground surface and the expanded portion of the anchor shaft and the upper portion of the anchor member are above the ground surface;
positioning a clamp member having a top with an aperture over the upper portion of the anchor shaft, said clamp member further having a terminal member disposed downwardly at the distal end of the top member,
contacting the top of the solar tracking device support member with the top of the clamp member, and contacting an outer surface of a first side wall of the solar tracking device support member with the terminal member of the clamp, and contacting an external surface of a second side wall of the solar tracking device support member with the contact member of the shaft;
disposing a biasing member above an upper surface of the top of the clamp of the solar tracking device support member, and about the upper portion of the anchor shaft;
installing a fastener on a distal end of the upper portion of the anchor shaft;
moving the fastener axially along the longitudinal axis of the anchor shaft toward the expanded portion of the anchor shaft thereby at least partially compressing the biasing member and securing the solar tracking device support member between the terminal member of the clamp and the expanded portion of the shaft.

30. A method for securing a solar tracking device support member having a top with an opening there through, downwardly disposed side members, said system comprising:
installing an anchor member including: an elongate anchor shaft having a longitudinal axis, at least one ground pull-out restraining member disposed on a lower portion of the anchor shaft, a contact member of the anchor shaft disposed longitudinally on an upper portion of the anchor shaft, wherein said ground pull-out restraining member is below the ground surface and the expanded portion of the anchor shaft and the upper portion of the anchor member are above the ground surface;
contacting an external surface of a first side wall of the solar tracking device support member with the contact member of the shaft;
positioning a clamp member having a top with an aperture over the upper portion of the anchor shaft, said clamp member further having a terminal member disposed downwardly at the distal end of the top member,
contacting the top of the solar tracking device support member with the top of the clamp member, and contacting an outer surface of a second side wall of the solar tracking device support member with the terminal member of the clamp, disposing a biasing member above an upper surface of the top of the clamp of the solar tracking device support member, and about the upper portion of the anchor shaft;
installing a fastener on a distal end of the upper portion of the anchor shaft;
moving the fastener axially along the longitudinal axis of the anchor shaft toward the expanded portion of the anchor shaft thereby at least partially compressing the biasing member and securing the solar tracking device support member between the terminal member of the clamp and the expanded portion of the shaft.
